(19) United States
(12) Patent Application Publication
(10) Pub. No.: US 2024/0147191 A1
(43) Pub. Date: May 2, 2024

(54) METHOD AND APPARATUS FOR 5MBS NATION-WIDE SERVICE

(71) Applicant: Telefonaktiebolaget LM Ericsson (publ), Stockholm (SE)

(72) Inventors: Jie LING, Shanghai (CN); Juying GAN, Shanghai (CN); Shabnam SULTANA, MONTREAL, Quebec (CA)

(73) Assignee: Telefonaktiebolaget LM Ericsson (publ), Stockholm (SE)

(21) Appl. No.: 18/276,204

(22) PCT Filed: Dec. 6, 2021
(86) PCT No.: PCT/EP2021/084372

§ 371 Date: Aug. 7, 2023

(30) Foreign Application Priority Data
Feb. 7, 2021 (WO) PCT/CN2021/075867

(51) Int. Cl. H04W 4/06

(52) U.S. Cl. CPC H04W 4/06; H04L 12/189

(57) ABSTRACT

Various embodiments of the present disclosure provide methods and apparatuses for 5MBS nation-wide services. According to an embodiment, a method implemented at a Multicast Broadcast Service Function, MBSF, comprises: receiving a first request to allocate a Multicast Broadcast Service, MBS, session identifier, ID, for an MBS session from an Application Function, AF; allocating the MBS session ID for the MBS session and selecting at least one Multicast Broadcast—Session Management Function, MB-SMF, based on the first request; providing the allocated MBS session ID to the at least one MB-SMF; and sending the allocated MBS session ID to the AF.

### FIELD OF THE INVENTION

The present disclosure generally relates to wireless communications, and more specifically, to methods and apparatuses for 5G Multicast Broadcast Service, 5MBS, nation-wide service.

### BACKGROUND

This section introduces aspects that may facilitate a better understanding of the disclosure. Accordingly, the statements of this section are to be read in this light and are not to be understood as admissions about what is in the prior art or what is not in the prior art.

The 3rd Generation Partnership Project (3GPP) has earlier developed Multicast/Broadcast Multimedia Subsystem (MBMS, see 3GPP TS 23.246 v16.1.0) for 3G networks for video multicast/broadcasting and streaming services and later introduced eMBMS (evolved MBMS) for Evolved Packet System (EPS). In Release-13 and Release-14, the MBMS system has been updated to support new services such as Public Safety, Cellular Internet of Thing (CIoT) and Vehicle-To-Everything (V2X).

The scope of a new Release-17 study in 3GPP SA2 working group is to study both multicast requirements and use cases for CIoT, Public Safety, V2X etc., and dedicated broadcasting requirements and use cases. The study targets the 5G Release 17 and the New Radio (NR) radio access. The study results so far has been documented in the 3GPP TR 23.757 V1.2.0.

Multicast/Broadcast services (MBS) are going to be supported in 5G NR as well. With the enhanced characteristics of the 5G NR, e.g. short delays, bandwidth etc., it is believed that Mission Critical Services (Mission Critical Push To Talk, MCPTT, Mission Critical Data, MCData, and Mission Critical Video, MCVideo), as well as V2X services will show an enhanced and much better performance on 5G NR.

So far, in 5MBS study TR 23.757 V1.2.0, it investigated 5MBS architecture to serve multicast broadcast services towards UE. Within the study, local MBS and location-dependent MBS services have been studied.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes a solution for national-wide content delivery via 5MBS. The proposed solution enables national content delivery via 5MBS.

According to a first aspect of the present disclosure, there is provided a method implemented at a Multicast Broadcast Service Function, MBSF. The method comprises: receiving a first request to allocate a Multicast Broadcast Service, MBS, session identifier, ID, for an MBS session from an Application Function, AF; allocating the MBS session ID for the MBS session and selecting at least one Multicast Broadcast—Session Management Function, MB-SMF, based on the first request; providing the allocated MBS session ID to the at least one MB-SMF; and sending the allocated MBS session ID to the AF.

In accordance with an exemplary embodiment, the at least one MB-SMF may comprise multiple MB-SMF entities, and the multiple MB-SMF entities may be associated with different regions.

In accordance with an exemplary embodiment, the first request may comprise service area information for the MBS session, and the at least one MB-SMF may be selected based on the service area information.

In accordance with an exemplary embodiment, the at least one MB-SMF may be selected further based on local configuration.

In accordance with an exemplary embodiment, the at least one MB-SMF may be selected by querying a Network Repository Function, NRF.

In accordance with an exemplary embodiment, the MBS session ID may be a Temporary Mobile Group Identity, TMGI.

In accordance with an exemplary embodiment, the method may further comprise registering an MBS session ID range associated with the MBSF with a Network Repository Function, NRF.

In accordance with an exemplary embodiment, the method may further comprise receiving a second request to start an MBS session from the AF, determining at least one MB-SMF based on the second request, sending the second request to the determined at least one MB-SMF, receiving MBS session resource information for the MBS session from the at least one MB-SMF, and sending the MBS session resource information to the AF.

In accordance with an exemplary embodiment, the method may further comprise requesting, in response to the second request, user plane information for the MBS session from a Multicast Broadcast Service Transport Function, MBSTF, and sending the user plane information in the MBSTF to the AF, without sending the MBS session resource information.

In accordance with an exemplary embodiment, the method may further comprise query, in response to the second request, a Policy Control Function, PCF, for quality of service, QoS, information for the MBS session based on service requirements in the second request.

In accordance with an exemplary embodiment, the second request may comprise an MBS session ID, service area information, and service requirements, and the at least one MB-SMF may be determined based on the service area information.

In accordance with an exemplary embodiment, the MBS session resource information may comprise N6 tunnel information for the MBS session in a Multicast Broadcast—User Plane Function, MB-UPF.

In accordance with an exemplary embodiment, the first request and the second request may be received in a single message.

According to a second aspect of the present disclosure, there is provided a method implemented at a network function. The method comprises: receiving a message associated with an MBS session; discovering an MBSF in response to the message; obtaining identification information of an MB-SMF associated with the MBS session from the MBSF; and obtaining an MBS session context for the MBS session from the MB-SMF identified by the identification information.

In accordance with an exemplary embodiment, discovering an MBSF may comprise querying an NRF for identification information of the MBSF based on an MBS session ID of the MBS session.

In accordance with an exemplary embodiment, obtaining identification information of an MB-SMF associated with the MBS session from the MBSF may comprise: providing an MBS session ID of the MBS session to the MBSF; obtaining the identification information of at least one MB-SMF, the identification information being associated with a service area; and selecting, in response to receiving the identification information of multiple MB-SMF entities, the identification information of one of the at least one MB-SMF based on location information of a terminal device associated with the MBS session.

In accordance with an exemplary embodiment, obtaining identification information of an MB-SMF associated with the MBS session from the MBSF may comprise: providing an MBS session ID of the MBS session and location information of a terminal device associated with the MBS session to the MBSF; and obtaining the identification information of a specific MB-SMF.

In accordance with an exemplary embodiment, obtaining an MBS session context for the MBS session from the MB-SMF identified by the identification information may comprise providing an MBS session ID of the MBS session and location information associated with a terminal device associated with the MBS session to the MB-SMF, and obtaining the MBS session context from the MB-SMF.

In accordance with an exemplary embodiment, the network function may be an Access and Mobility Management Function, AMF, or a Session Management Function, SMF.

In accordance with an exemplary embodiment, the network function may be the AMF, and the message may be a request to join the MBS session by a termina device or a request to create UE context during a handover procedure.

In accordance with an exemplary embodiment, the network function may be the SMF, and the message may be a request to join the MBS session by a terminal device or a request to update session management context during a handover procedure.

According to a third aspect of the present disclosure, there is provided a method implemented at a Multicast Broadcast Service Transport Function, MBSTF. The method comprises: receiving MBS session contents of an MBS session from an AF; obtaining at least one duplicate of the MBS session contents according to service area information of the MBS session; and sending the at least one duplicate to a respective MB-UPF based on MBS session resource information for the MBS session in the respective MB-UPF.

In accordance with an exemplary embodiment, the MBS session resource information may comprise N6 tunnel information in the MB-UPF.

According to a fourth aspect of the present disclosure, there is provided a network node to implement Multicast Broadcast Service Function, MBSF. The network node may comprise one or more processors and one or more memories comprising computer program codes. The one or more memories and the computer program codes may be configured to, with the one or more processors, cause the network node at least to perform any step of the method according to the first aspect of the present disclosure.

According to a fifth aspect of the present disclosure, there is provided a network node to implement a network function. The network node may comprise one or more processors and one or more memories comprising computer program codes. The one or more memories and the computer program codes may be configured to, with the one or more processors, cause the network node at least to perform any step of the method according to the second aspect of the present disclosure.

According to a sixth aspect of the present disclosure, there is provided a network node to implement Multicast Broadcast Service Transport Function, MBSTF. The network node may comprise one or more processors and one or more memories comprising computer program codes. The one or more memories and the computer program codes may be configured to, with the one or more processors, cause the network node at least to perform any step of the method according to the third aspect of the present disclosure.

According to a seventh aspect of the present disclosure, there is provided a Multicast Broadcast Service, MBS, system. The MBS system comprises an MBSF according to the fourth aspect of the present disclosure, a plurality of MB-SMFs associated with a plurality of different regions communicatively coupled to the MBSF, and a plurality of MB-UPFs, each of which is communicative coupled to the respective one of the plurality of MB-SMFs.

In accordance with an exemplary embodiment, the MBS system may further comprise an SMF according to the fifth aspect of the present disclosure, communicatively coupled to the MBSF and the plurality of MB-SMFs; or a plurality of AMFs according to the fifth aspect of the present disclosure, communicatively coupled to the MBSF and the plurality of MB-SMFs.

In accordance with an exemplary embodiment, the MBS system may further comprise an MBSTF according to the sixth aspect of the present disclosure, communicatively coupled to the plurality of MB-UPFs.

According to an eighth aspect of the present disclosure, there is provided a computer-readable medium having computer program codes embodied thereon which, when executed on a computer, cause the computer to perform any step of the method according to the first aspect of the present disclosure.

According to a ninth aspect of the present disclosure, there is provided a computer-readable medium having computer program codes embodied thereon which, when executed on a computer, cause the computer to perform any step of the method according to the second aspect of the present disclosure.

According to a tenth aspect of the present disclosure, there is provided a computer-readable medium having computer program codes embodied thereon which, when executed on a computer, cause the computer to perform any step of the method according to the third aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating a procedure of initial multicast group configuration via Network Exposure Function (NEF);

FIG. 2 is a diagram illustrating a session start procedure;

FIG. 3 is a diagram illustrating a reference deployment architecture of an MBS system;

FIG. 4 is a diagram illustrating a deployment architecture of an MBS system according to some embodiments of the present disclosure;

FIG. 5 is a diagram illustrating a procedure of MBS session start/configuration according to some embodiments of the present disclosure;

FIG. 6 is a diagram illustrating a procedure of joining an MBS session according to some embodiments of the present disclosure;

FIG. 7 is a diagram illustrating a handover procedure for MBS service according to some embodiments of the present disclosure;

FIG. 8 is a flowchart illustrating a method implemented at an MBSF according to some embodiments of the present disclosure;

FIG. 9 is a flowchart illustrating a method implemented at the MBSF according to some embodiments of the present disclosure;

FIG. 10 is a flowchart illustrating a method implemented at a network function according to some embodiments of the present disclosure;

FIG. 11 is a flowchart illustrating a method implemented at an MBSTF according to some embodiments of the present disclosure;

FIG. 12 is a block diagram illustrating an apparatus according to some embodiments of the present disclosure;

FIG. 13 is a block diagram illustrating an apparatus according to some embodiments of the present disclosure;

FIG. 14 is a block diagram illustrating an apparatus according to some embodiments of the present disclosure; and

FIG. 15 is a block diagram illustrating an apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network node” refers to a network device to implement a network function in 5G core (5GC) network. The network function can be implemented either as a network element on a dedicated hardware, as a software instance running on a dedicated hardware, or as a virtualized function instantiated on an appropriate platform, e.g. on a cloud infrastructure.

The term “terminal device” refers to any end device that can access the 5G network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In the following description, the term “nation-wide area” may refer to a nation that consists of multiple regions where content needs to be provided for each region.

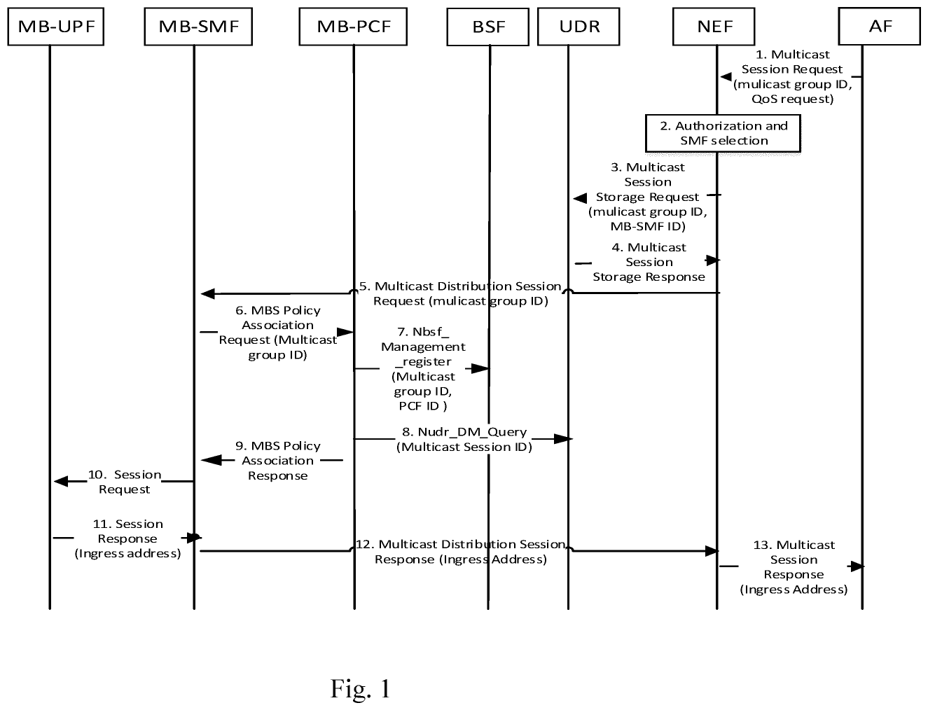

3GPP TR 23.757 V1.2.0 provides existing solutions for local MBS service. Solution #3 (SMF-centric approach, Source Specific Multicast (SSM) IP address is MBS Session ID) discussed how an MBS multicast service can be configured. FIG. 1 shows the procedure of initial multicast group configuration via NEF. The configuration steps are below.

Step 1: AF of a content provider may register at NEF that it provides contents for a multicast group (identified by multicast group ID which may be IP multicast address). Multicast information may further include media type information (e.g., audio, video . . . ), QoS requirements, user equipment (UE) authorization information (e.g. a Generic Public Subscription Identifier (GPSI) or an External Group Id or a UE ID to identify UEs authorized to join the multicast service), service area identifying the service scope, and start and end time of MBS. The AF may also request the allocation of an ingress transport address where to send tunnelled multicast data.

Step 2: NEF checks authorization of the content provider. NEF selects MB-SMF as an ingress control node, possibly based on location area.

Steps 3-4: NEF requests storage of multicast session context at Unified Data Repository (UDR) and provides multicast group ID and selected MB-SMF ID.

Step 5: NEF requests MB-SMF to reserve ingress resources for a multicast distribution session and provides the multicast group ID. It also indicates if the allocation of an ingress transport address is requested.

Step 6: The MB-SMF sends SM MBS Policy Association Request to MB-PCF with the multicast group ID, AF Identifier, and the QoS requirements.

Step 7: The MB-PCF registers at the Binding Support Function (BSF) that it handles the multicast session. It provides an identifier that the policy association is for multicast and the multicast group ID, its own PCF ID and optionally its PCF set ID.

Step 8: The MB-PCF may query the UDR for policy input related to the multicast session.

Step 9: The MB-PCF responds with SM MBS Policy Association Response with policies for the multicast group ID. In addition, it determines whether the request is authorized and notifies the NEF if the request is not authorized. If the request is authorized, the PCF derives the required QoS parameters based on the information provided by the NEF and determines whether this QoS is allowed (according to the PCF configuration for this AF), and notifies the result to the MB-SMF. The PCF notifies the MB-SMF whether the transmission resources corresponding to the QoS request are established or not. If the request is not authorized, the required QoS is not allowed, or transmission resources are not established, MB-SMF responds to the NEF in step 12 with a Result value indicating the failure cause, and NEF further notifies AF in step 13.

Step 10: MB-SMF selects the MB-UPF and requests it to reserve user plane ingress resources. If multicast transport of the multicast data towards RAN nodes is to be used, the MB-SMF also request the MB-UPF to reserve for the outgoing data a tunnel endpoint and the related identifiers (source IP address, source specific multicast address and GTP Tunnel ID) and to forward data received at the user plane ingress resource using that tunnel endpoint.

Step 11: If requested, MB-UPF selects an ingress address (IP address and port) and a tunnel endpoint for the outgoing data and provides it to MB-SMF.

Step 12: MB-SMF indicates the possibly allocated ingress address to the NEF. It also indicates the success or failure of reserving transmission resources.

Step 13: The NEF indicates the possibly allocated ingress address to the AF.

Solution #2 (AMF-centric approach, TMGI is MBS Session ID) discussed how an MBS multicast service can be started. The Session Start procedure is used by the AF to activate an MB Session and start transmission of multicast/broadcast data. During the Session Start procedure, resources for the MB Session are setup in the MB-UPF and in the NG-RAN.

When the multicast transport is described below, source specific multicasting is assumed. That is, the parameter “LL MC address (Lower Layer Multicast IP address)” is assumed to be accompanied by a “Source host address” parameter in the descriptions below.

This clause assumes that 5MBS is supported by NG-RAN. For NG-RAN not supporting 5MBS, 5GC Individual MBS traffic delivery may be applied for the MBS session, please refer to clause 6.2.2.2a.

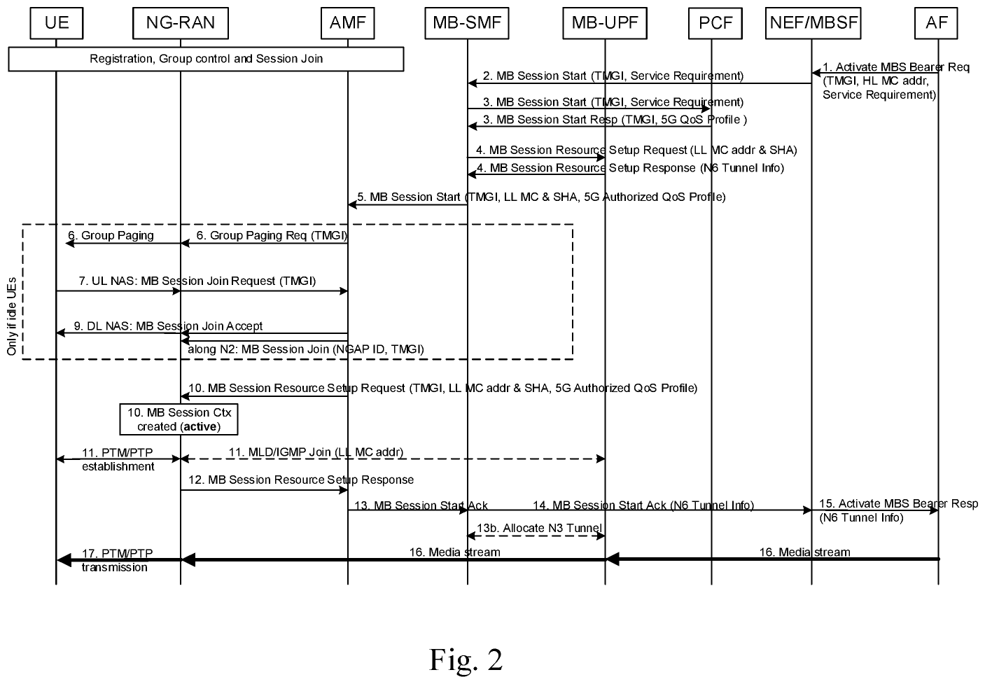

FIG. 2 shows a diagram illustrating a session start procedure in TR23.757 V1.2.0 clause 6.2.2.2. The steps are described as below.

Step 1: The AF requests activation of an MB session by sending an Activate MBS Bearer Request (TMGI, HL MC Address, Service Requirement) message to the NEF/MBSF. AF has allocated a Higher Layer IP Multicast Address (HL MC Address). Service Requirement for the MB Session may be included. If multiple MBS QoS Flows are expected to be established, then the AF needs to provide different packet filters and associated service requirement.

NOTE 1: A combined TMGI allocation and Session start on an N33 API is assumed to use Allocate TMGI Request/Response+MB Session Start messages on the N29 interface.

Step 2: The NEF/MBSF checks if the input parameters e.g. HL MC address are valid. NEF/MBSF sets the MB Session Context to active. NEF/MBSF sends a MB Session Start (TMGI, Service Requirement) message to the MB-SMF.

Step 3: MB-SMF sends the TMGI for the MB Session and the Service Requirement to the PCF. The PCF returns a 5G QoS Profile, which the MB-SMF uses as the 5G Authorized QoS Profile for the MB Session. If multiple MBS service requirements are received, then PCF will provide multiple 5G Authorized QoS Profiles.

Step 4: MB-SMF sets up the N6 resources for the MB Session in the MB-UPF and the N3 resources for transport multicast tunnelling using the LL MC address allocated for the TMGI.

Optionally, media reception in MB-UPF is un-tunnelled, in which case the MB-SMF also provides the HL MC Address so that the MB-UPF can send IGMP/MLD join and receive the (un-tunnelled) IP Multicast Media stream. If N6 tunnelling is used, the MB-UPF allocates N6 tunnel information (e.g. UDP port and IP address) and returns to the MB-SMF. MB-SMF stores the received information in the MB Session Context. If multiple MBS QoS Flows are established, the MB-UPF map the downlink MBS data to the MBS QoS Flow based on the packet filters which could be HL MC address and ports, or unicast UDP tunnel information.

Step 5: MB-SMF sets the MB Session Context to active and sends MB Session Start (TMGI, LL MC Address and source host address, 5G Authorized QoS Profile) messages to all AMFs that has earlier joined the MB Session. When the AMF receives the MB Session Start message, AMF sets its MB Session Context to active state. The AMF proceeds with step 6 and step 10 onwards in parallel.

NOTE 2: LL MC Address and source host address of MB-UPF is provided if multicast transport is configured to be used between the NG-RAN and MB-UPF nodes. Otherwise N3 point-to-point transport is assumed.

Step 6: If the AMF has CM-IDLE UEs that have joined the MB Session (i.e. any CM-IDLE UE with the specific TMGI of a MB Session in stored in the UE Context of the AMF), the AMF performs group paging including the Group Paging Identity (TMGI) in the Paging message in the registration areas of the CM-IDLE UEs. The NG-RAN node triggers group paging. The AMF determines the group paging area by combing the paging areas of the individual UE within the multicast group.

NOTE 3: How to handle group paging and how to efficiently listen for both unicast paging and group paging etc. are to be studied by RAN WGs.

Steps 7-9: UEs respond to the Group paging e.g. by sending UL NAS MB Session Join Request (TMGI) to AMF (see clause 6.2.2.1 steps 6 to 8).

Step 10: The AMF sends a MB Session Resource Setup Request (TMGI, LL MC and source host address, 5G Authorized QoS Profile) message to all RAN nodes where CM CONNECTED UEs that has joined the TMGI resides. NG-RAN creates a MB Session Context (if it not already exists), sets it to “active” state, stores the TMGI, the QoS Profile and a list of AMF IDs in the MB Session Context. If a NG RAN node receives multiple MB Session Resource Setup Request messages for the same TMGI (e.g. from several AMFs that the NG-RAN is connected to) (and even if the LL MCs are different in the case of multiple MB-UPFs), NG-RAN stores each sender AMF ID in the MB Session Context, but only performs step 11 once (instead continues at step 12). The LL MC Address and Source Host Address are optional parameters and only provided by AMF to NG-RAN if N3 multicast transport is configured to be used in the 5GC.

Step 11: If NG-RAN prefers to use N3 multicast transport (and if LL MC Address is available in NG-RAN), the NG-RAN joins the multicast group (i.e. LL MC Address). NG-RAN establishes PTM or PTP DL resources for the MB Session, and if there are UEs in CM-Connected with RRC_INACTIVE state with the TMGI in their UE Contexts, NG-RAN performs the Network triggered transition from RRC_INACTIVE to RRC_CONNECTED procedure for those UEs (see TS 38.300 [10]).

Step 12: The NG-RAN reports successful establishment of the MB Session resources (which may include multiple MBS QoS Flows) by sending MB Session Resource Setup Response (TMGI, Tunnel Info) message(s) to the AMF. NG-RAN provides its Tunnel Info if NG-RAN prefers to use N3 point-to-point transport (or if the LL MC Address is not available in NG-RAN) between the NG-RAN and MB-UPF.

Step 13: The AMF sends MB Session Start Ack (TMGI, Tunnel Info) to the MB-SMF.

NOTE 4: The AMF may send an Ack for each response it receives from NG-RAN nodes (e.g. useful for small MCPTT areas). That is, steps 13 to 15 may be repeated multiple times (once for each involved NG RAN node). The AMF may also use an upper limit for the number of Acks sent and fallback to aggregated Acks if the number of RAN Acks go beyond the limit (to reduce signaling load). That is, collect status from all or a number of downstream nodes (with time out) and then make an aggregated report. An MCPTT server may want to start an MCPTT call (i.e. to transmit media) as soon as possible, e.g. already when a few members of a group can successfully receive the media. In such cases it is reasonable to be able to send intermediate and multiple acknowledgements to the AF.

Step 13b: If N3 point-to-point transport is to be used (i.e. Tunnel Info is present in the MB Session Start Ack message from AMF), the MB-SMF sends an N4 request to the MB-UPF to allocate the N3 point-to-point transport tunnel for a replicated MBS stream for the MB Session.

Steps 14-15: The MB-SMF sends the MB Session Start Ack (TMGI) message to the NEF/MBSF. N6 Tunnel info is included in the response if not already provided to the AF. The NEF/MBSF sends an Activate MBS Bearer Response including the N6 Tunnel Info to the AF.

Step 16: The MB Session is now active. The AF starts transmitting the downlink (DL) media stream using the N6 Tunnel Info, or optionally un-tunnelled i.e. as an IP multicast stream using the HL MC address.

Step 17: The NG-RAN transmits the received DL media stream using DL PTM or PTP resources.

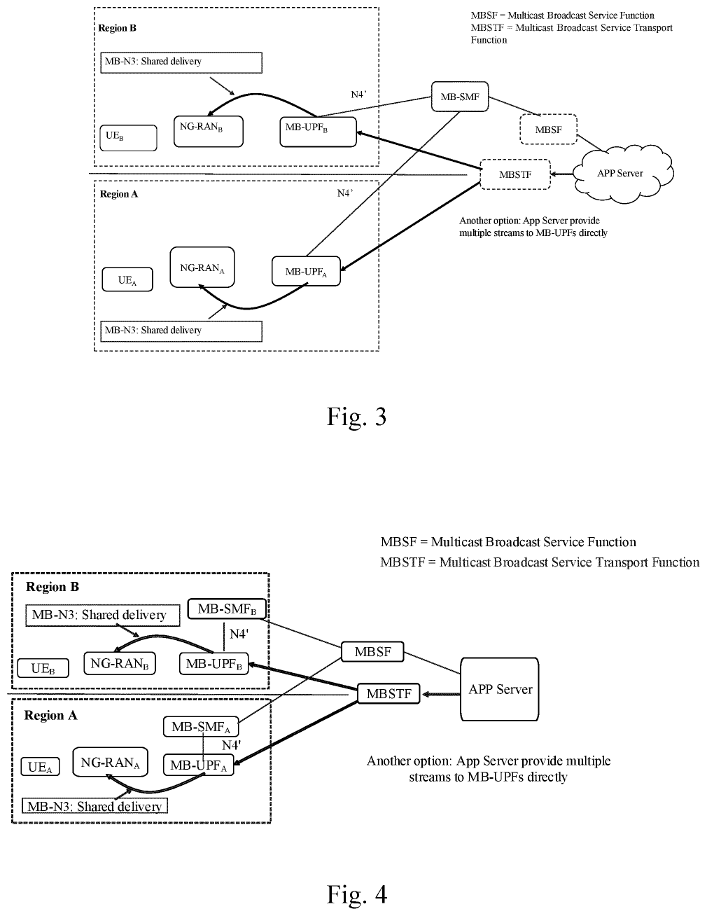

Based on the current implementation in TR 23.757 V1.2.0, a reference deployment architecture of an MBS system may be provided as shown in FIG. 3. As shown in FIG. 3, an MB-SMF is centralized deployed. It accepts SSM IP from an application server (denoted as “App Server” in FIG. 3) for SMF-centric approach, or allocates TMGI for AMF-centric approach. Multiple MB-UPFs are deployed in different regions and deliver contents to Regional NG-RANs. In FIG. 3, MB-UPFA is deployed in Region A, and MB-UPFB is deployed in Region B. MB-UPFA and MB-UPFB deliver contents to NG-RANA and NG-RANB respectively. The application server starts/configures an MBS session towards MB-SMF, or via MBSF (also known as MBSF-C). Optionally, NEF can be involved if the application server is deployed in an external digital network (DN). MB-SMF selects and sets up user plane to multiple MB-UPFs based on a service area indicated by the application server. The application server duplicates contents directly towards MB-UPFs or via MBSTF (also known as MBSF-U or MBSU). MB-UPFs in the regions distribute contents towards the respective NG-RANs for the MBS session.

How national content delivery can be achieved in 5MBS is not properly addressed in TR 23.757 V1.2.0. If the reference deployment architecture as shown in FIG. 3 is used, it implies that the N4′ interface (which is an updated version of N4) between MB-SMF and MB-UPF has to be cross multiple regions, which does not follow the current 5GC principles and is not allowed by operators. Therefore, it is desirable for a new solution of 5MBS nation-wide services.

In accordance with some exemplary embodiments, the present disclosure provides a solution for national-wide content delivery via 5MBS. The solution may be applied to the 5MBS system including a terminal device such as a UE and a plurality of network functions such as MBSF, MB-SMF, MB-UPF, AMF, SMF, etc. With the solution, MB-SMFs and MB-UPFs are regionally deployed, so that the N4 interfaces between MB-SMFs and MB-UPFs will not cross regions. Thus, the current 5GC principle can be followed.

It is noted that some embodiments of the present disclosure are mainly described in relation to 5MBS specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

FIG. 4 shows a deployment architecture of the MBS system according to some embodiments of the present disclosure. In the MBS system as shown in FIG. 4, an MBSF is centrally deployed and responsible for MB session ID (which is TMGI) allocation. A plurality of MB-SMFs and a plurality of MB-UPFs are deployed in different regions. In FIG. 4, MB-SMFB and MB-UPFB are deployed in Region B, and MB-SMFA and MB-UPFA are deployed in Region A. An application server (also denoted as App Server) duplicates MBS session contents for an MBS session towards the MB-UPFs directly or via an MBSTF. Each MB-UPF distributes the contents towards NG-RAN in the region.

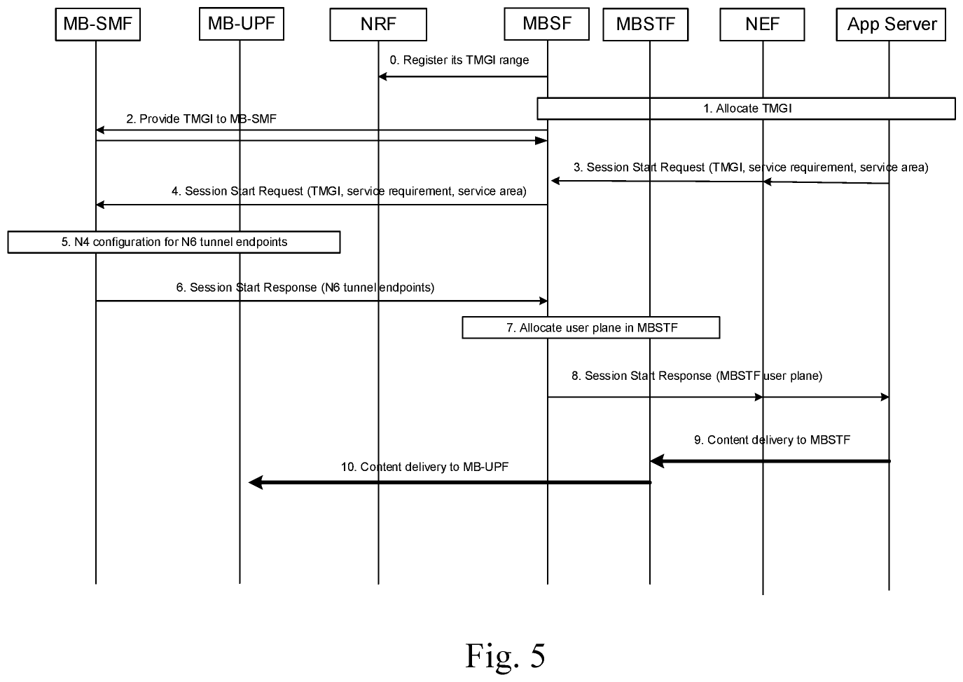

FIG. 5 is a diagram illustrating a procedure of MBS session start/configuration according to some embodiments of the present disclosure. As shown in FIG. 5, at step 0, when the MBSF is brought into service, the MBSF registers itself and associated TMGI range towards an NRF. When the App Server would like to start an MBS session, at step 1, the App Server requests the MBSF to allocate TMGI (which is used as an MBS Session ID) for the MBS session and gets the TMGI from the MBSF. If the App Server is deployed in an external DN, the request may be via an NEF. At step 2, the MBSF selects one or more MB-SMFs based on local configuration or by means of querying the NRF based on location (or service area), and then provides the allocated TMGI to the one or more MB-SMFs. Such step is applicable for multicast, in case UEs are allowed to join before session start. For broadcast, this step can be skipped.

Later, at step 3, the App Server sends a Session Start Request to the MBSF with TMGI, service requirements, service area and other parameters. The MBSF may interact with a PCF to get a QoS profile based on the service requirements, if the PCF is centrally deployed. At step 4, the MBSF sends the Session Start Request to one or more MB-SMFs based on the service area. The MB-SMF(s) may interact with the PCF(s) deployed in the corresponding region to get the QoS profile based on the service requirements. At step 5, each of the one or more MB-SMFs selects an MB-UPF and allocates N6 tunnel endpoints in the MB-UPF. The selection may be done by local configuration or the query from the NRF.

At step 6, the MB-SMF(s) responds N6 tunnel endpoints to the MBSF via a Session Start Response. Then at step 7, the MBSF allocates user plane resources in an MBSTF. This step can be executed in parallel with step 4. Further, at step 8, the MBSF responds MBSTF user plane resources to the App Server via the Session Start Response.

At step 9, the App Server delivers contents for the MBS session to the MBSTF based on the user plane resources received in step 8. Then at step 10, the MBSTF duplicates the contents and delivers to the MB-UPF(s) based on the N6 tunnel endpoints received in step 6. Alternatively, the App Server may duplicate the contents and deliver the contents to the N6 tunnel endpoints in the MB-UPF(s) without involvement of the MBSTF.

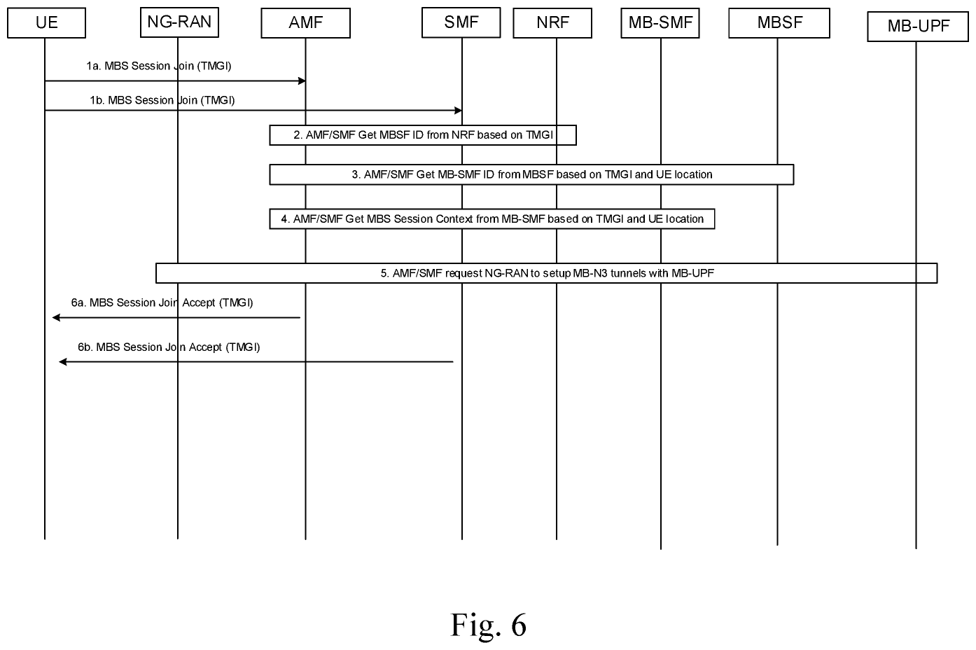

FIG. 6 is a diagram illustrating a procedure of joining an MBS session according to some embodiments of the present disclosure. The procedure may be AMF-centric or SMF-centric. As shown in FIG. 6, at step 1a, in the AMF-centric approach, UE sends an MBS Session Join request to the AMF with the MBS Session ID (i.e. TMGI). Alternatively, in the SMF-centric approach, at step 1b, the UE sends the MBS Session Join request to the SMF with the MBS Session ID (i.e. TMGI). It can be implemented via a PDU Session Modification Request or a PDU Session Establishment Request. Then at step 2, the AMF or SMF discovers the MBSF. In an embodiment, the AMF or SMF may query the NRF based on the MBS Session ID to get an MBSF ID. With the MBSF ID, the AMF or SMF contacts the MBSF at step 3. The AMF or SMF may provide the MBS Session ID and UE location to the MBSF, and receive an MB-SMF ID from the MBSF. Alternatively, the AMF or SMF may provide the MBS Session ID to the MBSF. If multiple MB-SMF IDs are involved for the same MBS Session, the MBSF may return multiple MB-SMF IDs, each of the MB-SMF IDs being associated with a service area. Then the AMF or SMF may select a proper MB-SMF ID base on the UE location.

At step 4, with the MB-SMF ID, the AMF or SMF contacts the corresponding MB-SMF. The AMF or SMF may provide the MBS Session ID and the UE location to the MB-SMF and receive MBS Session Context for the MBS session. At step 5, the AMF or SMF sets up MB Session Resources towards NG-RAN. If an MB-N3 tunnel is transported over multicast, NG-RAN can join the multicast group to receive data, which was provided in the MBS Session Context. If an MB-N3 tunnel is transported over point-to-point connection, NG-RAN informs the MB-UPF about its MB-N3 tunnel endpoints via the AMF and the MB-SMF. Then in the AMF-centric approach, at step 6a, the AMF sends MBS Session Join Accept to the UE. Alternatively, in the SMF-centric approach, at step 6b, the SMF sends MBS Session Join Accept to the UE.

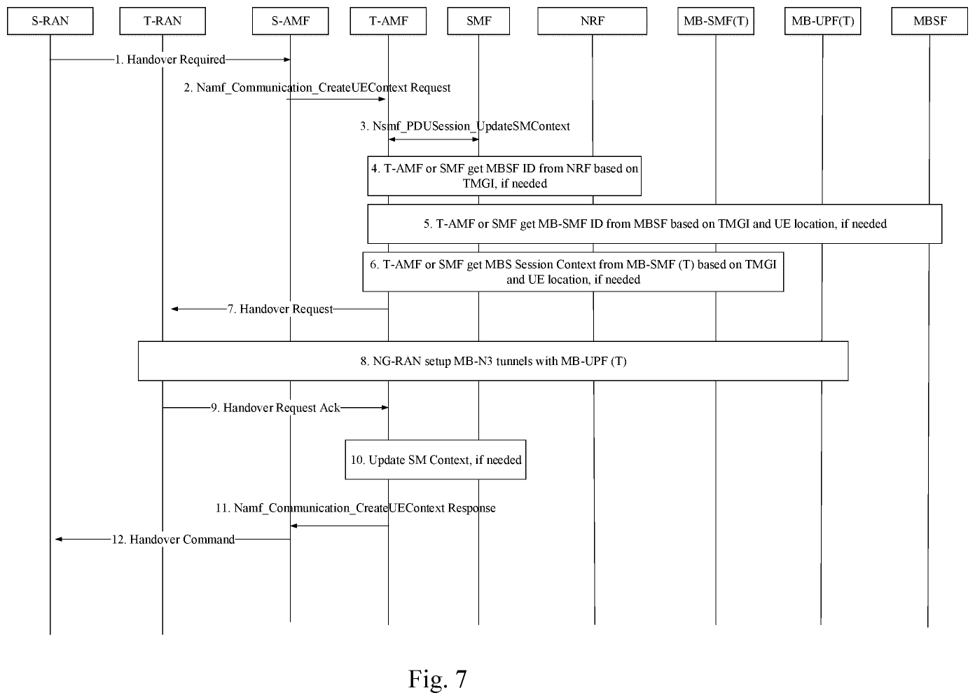

FIG. 7 is a diagram illustrating a handover procedure for MBS nation-wide service according to some embodiments of the present disclosure. When the UE moves to a new region and target NG-RAN supports 5MBS, the handover procedure as shown in FIG. 7 is initiated.

As shown in FIG. 7, at step 1, the source NG-RAN (S-RAN) sends a Handover Request to the source AMF (S-AMF). Then at step 2, the source AMF sends a Create UE Context Request to the target AMF (T-AMF). The target AMF updates SM context to the SMF at step 3, if needed. In the AMF-centric approach, at step 4, the target AMF gets the MBSF ID from the NRF based on the MBS Session ID for the MBS session that the UE joined, if needed. For the SMF-centric approach, the SMF should already have the MBSF ID. Then at step 5, the target AMF or SMF gets the MB-SMF ID from the MBSF based on the MBS Session ID and the UE location, if needed. At step 6, the target AMF or SMF gets the MBS Session Context from the MB-SMF in the target region, based on the MBS Session ID and the UE location, if needed.

Then at step 7, the target AMF sends a Handover Request to the target NG-RAN (T-RAN), and the target NG-RAN sets up the MB Session Resources with the MB-UPF (MB-UPF(T)) in the target region at step 8. If an MB-N3 tunnel is transported over multicast, the target NG-RAN can join the multicast group to receive data, which was provided in the MBS Session Context. If an MB-N3 tunnel is transported over point-to-point connection, the target NG-RAN informs the MB-UPF in target region about its MB-N3 tunnel endpoints via the target AMF and the MB-SMF in the target region. Then at step 9, the target NG-RAN sends a Handover Request Ack to the target AMF, and the target AMF updates the SM context to the SMF at step 10, if needed. At step 11, the target AMF sends a Create UE Context Response to the source AMF, and the source AMF sends a Handover Command to the source NG-RAN at step 12.

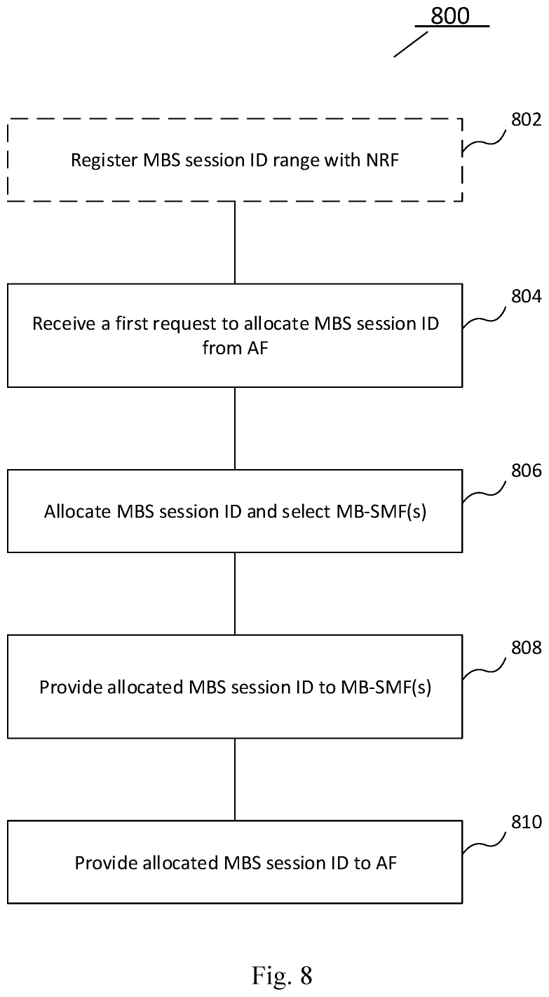

FIG. 8 is a flowchart illustrating a method 800 according to some embodiments of the present disclosure. The method 800 illustrated in FIG. 8 may be performed by an apparatus implemented in/as the MBSF or communicatively coupled to the MBSF. The MBSF may be same as the MBSF in the MBS system as shown in FIG. 3.

According to the exemplary method 800 illustrated in FIG. 8, the MBSF receives a first request to allocate an MBS session ID for an MBS session from the AF, as shown in block 804. In some embodiments, the first request may be received directly from the AF, or via the NEF if the AF is deployed in the external DN. In some embodiments, the MBS session ID may be a TMGI. The first request may comprise service area information identifying a service scope of the MBS session. In some embodiments, the first request may be an Allocate TMGI Request.

In block 806, upon receipt of the first request, the MBSF allocates the MBS session ID for the MBS session and selects at least one MB-SMF. As described above, the MB-SMF is deployed per region in the MBS system. Thus, the selection of the MB-SMF(s) may be based on the service area information. In some embodiments, the at least one MB-SMF may be selected further based on local configuration. Alternatively, the MBSF may query the NRF based on the service area information to select the MB-SMF(s).

Then in block 808, the MBSF provides the allocated MBS session ID to the selected at least one MB-SMF. Each of the MB-SMF may then respond to the MBSF. In block 810, the MBSF sends the allocated MBS session ID for the MBS session to the AF.

Additionally, in some embodiments, the MBSF may register itself and associated MBS session ID range with the NRF in block 802.

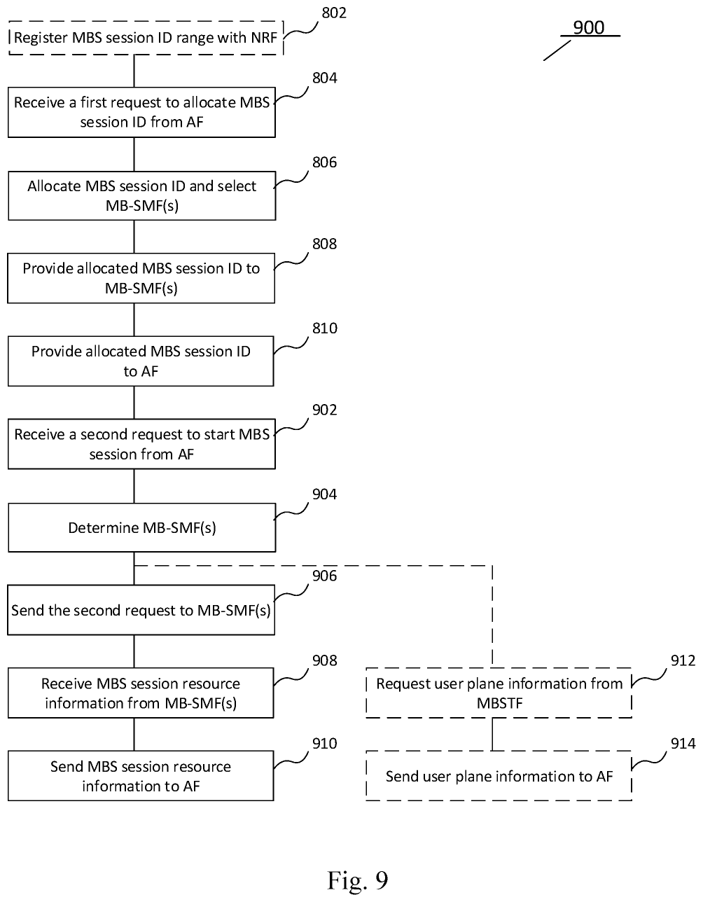

FIG. 9 illustrates a method 900 implemented at the MBSF according to some embodiments of the present disclosure. In this embodiment, in addition to the operations as shown in FIG. 8, the method 900 comprises operations for MBS session start procedure.

As shown in FIG. 9, the MBSF receives a second request to start an MBS session from the AF in block 902. In some embodiments, the second request may comprise an MBS session ID, service area information, and service requirements. The MBS session ID identifies the MBS session to be started, the service area information identifies the service scope of the MBS session, and the service requirements may indicate QoS requirements for the MBS session. In some embodiments, the second request may be a Session Start Request.

In block 904, the MBSF determines at least one MB-SMF based on the second request. In some embodiments, the MB-SMF(s) may be determined based on the service area information in the second request. Additionally, in some embodiments, the MBSF may query the PCF for QoS information for the MBS session based on the service requirements in the second request. In this case, the PCF may be centrally deployed in the MBS system.

Then in block 906, the MBSF sends the second request to the determined MB-SMF(s). Upon receipt of the second request, the MB-SMF(s) in the region may query the PCF deployed associated with the region for QoS information based on the service requirements. Then the MB-SMF(s) may allocate MBS session resource information for the MBS session in the respective MB-UPF(s), and send the MBS session resource information to the MBSF. In some embodiments, the MBS session resource information may comprise N6 tunnel information, which comprise N6 tunnel endpoints in the MB-UPF. Upon receipt of the MBS session resource information from the MB-SMF(s) in block 908, the MBSF may send the MBS session resource information directly to the AF, in block 910. In some embodiments, the MBS session resource information may be included in a Session Start Response. In this case, the AF duplicates and deliver MBS session contents to N6 tunnel endpoints in the MB-UPF(s) directly. Alternatively, the AF may multicast MBS session contents and the MB-UPF(s) may join the multicast group (SSM) to receive the contents.

Additionally, in some embodiments, the MBSF may request user plane information for the MBS session from the MBSTF in block 912, and send the user plane information in the MBSTF to the AF in block 914. In this case, the MBSF needs not send the MBS session resource information to the AF. In some embodiments, the user plane information may be included in the Session Start Response. In this case, the AF delivers MBS session contents to the MBSTF, and the MBSTF duplicates and delivers the MBS session contents to N6 tunnel endpoints in the MB-UPF(s). Alternatively, the AF may multicast MBS session contents and the MBSTF may join the multicast group (SSM) to receive the contents. Also, alternatively, the MBSTF may multicast the MBS session contents and the MB-UPF(s) may join the multicast group (SSM) to receive the contents. Note that FIG. 9 shows that block 912 is performed after block 904, those skilled in the art will appreciate that the block 912 can be performed in parallel with block 904.

Alternatively, in some embodiments, the MBSF may receive the first request and the second request in a single message.

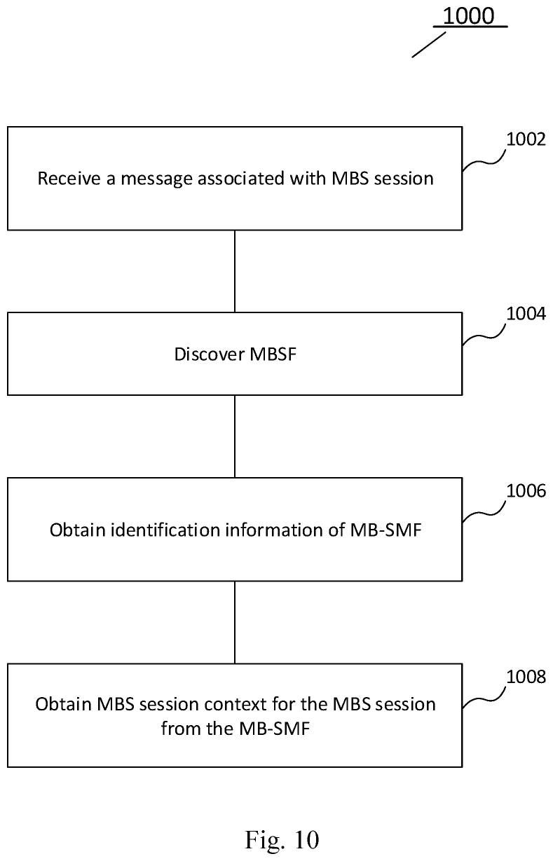

FIG. 10 is a flowchart illustrating a method 1000 implemented at a network function according to some embodiments of the present disclosure. The method 1000 illustrated in FIG. 10 may be performed by an apparatus implemented in/as the AMF or SMF.

According to the exemplary method 1000 illustrated in FIG. 10, the AMF or SMF receives a message associated with an MBS session, as shown in block 1002. The message may comprise the MBS session ID. In the case of AMF, the message may be a request to join the MBS session by UE or a request to create UE context from another AMF during a handover procedure. In the case of SMF, the message may be a request to join the MBS session by UE or a request to update session management context from a target AMF in a target region during a handover procedure. For example, the request to join the MBS session may be an MBS Session Join request.

Then in block 1004, the AMF or SMF discovers an MBSF based on the MBS session ID of the MBS session. In some embodiments, the AMF or SMF may query the NRF for identification information of the MBSF, e.g. MBSF ID. As described above, the MBSF and its associated MBS session ID range have been registered in the NRF. Thus, the AMF or SMF may obtain the MBSF ID from the NRF.

After obtaining the MBSF ID, the AMF or SMF may contact the MBSF identified by the MBSF ID to obtain identification information of an MB-SMF associated with the MBS session in block 1006. In some embodiments, the AMF or SMF may provide the MBS session ID to the MBSF and obtain the identification information of the MB-SMF(s) (e.g. MB-SMF ID(s)) from the MBSF. The identification information may be associated with a service area. If the identification information of multiple MB-SMF(s) is obtained, the AMF or SMF may select the identification information of one of the multiple MB-SMFs based on location information of the UE associated with the MBS session. Alternatively, in some embodiments, the AMF or SMF may provide the MBS session ID of the MBS session and location information of the UE associated with the MBS session to the MBSF. The MBSF may select one MB-SMF based on the MBS session ID and the location information and provide the identification information of the one MB-SMF to the AMF or SMF.

Then in block 1008, the AMF or SMF obtains an MBS session context for the MBS session from the MB-SMF identified by the identification information. In some embodiments, the AMF or SMF may provide the MBS session ID and the location information to the MB-SMF, and obtain the MBS session context from the MB-SMF.

FIG. 11 is a flowchart illustrating a method 1100 implemented at the MBSTF according to some embodiments of the present disclosure. These embodiments are applicable to the case where the MBSTF provides the user plane information for the MBS session to the MBSF which then sends the user plane information to the AF.

As shown in FIG. 11, the MBSTF receives MBS session contents of an MBS session from the AF in block 1100. Then in block 1104, the MBSTF duplicates the MBS session contents to obtain at least one duplicate according to the service area information of the MBS session. Then the MBSTF delivers the duplicate(s) to the respective MB-UPF(s), e.g. the N6 tunnel endpoints in the MB-UPF, in block 1106.

The various blocks shown in FIGS. 8 to 11 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

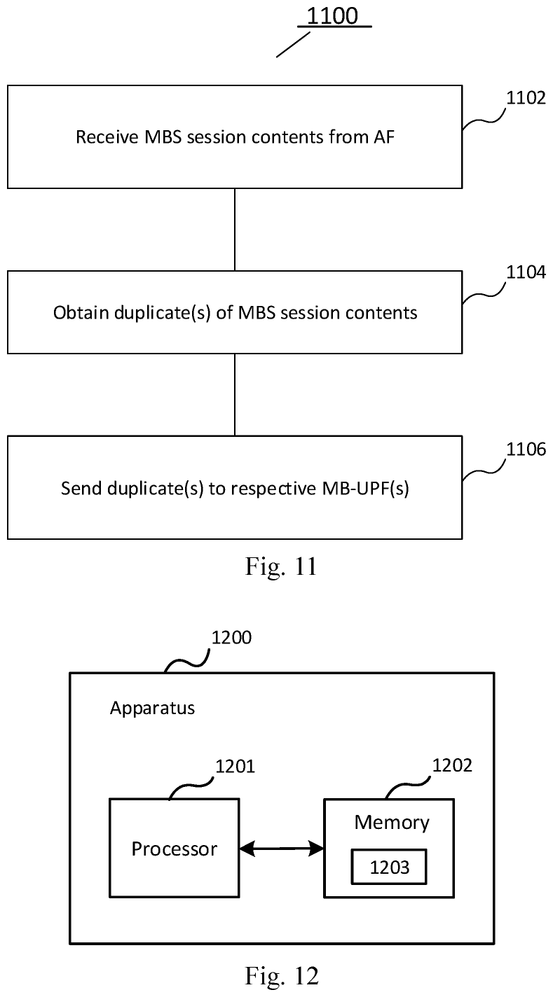

FIG. 12 is a block diagram illustrating an apparatus 1200 according to various embodiments of the present disclosure. As shown in FIG. 12, the apparatus 1200 may comprise one or more processors such as processor 1201 and one or more memories such as memory 1202 storing computer program codes 1203. The memory 1202 may be non-transitory machine/processor/computer readable storage medium. In accordance with some exemplary embodiments, the apparatus 1200 may be implemented as an integrated circuit chip or module that can be plugged or installed into a network node to implement MBSF as described with respect to FIGS. 8-9, or a network node to implement AMF or SMF as described with respect to FIG. 10, or a network node to implement MBSTF as described with respect to FIG. 11.

In some implementations, the one or more memories 1202 and the computer program codes 1603 may be configured to, with the one or more processors 1201, cause the apparatus 1200 at least to perform any operation of the method as described in connection with FIG. 8-9. In such embodiments, the apparatus 1200 may be implemented as at least part of or communicatively coupled to the network node to implement MBSF as described above. As a particular example, the apparatus 1200 may be implemented as a network node to implement MBSF.

In other implementations, the one or more memories 1202 and the computer program codes 1203 may be configured to, with the one or more processors 1201, cause the apparatus 1200 at least to perform any operation of the method as described in connection with FIG. 10. In such embodiments, the apparatus 1200 may be implemented as at least part of or communicatively coupled to the network node to implement AMF or SMF as described above. As a particular example, the apparatus 1200 may be implemented as a network node to implement AMF or a SMF.

In other implementations, the one or more memories 1202 and the computer program codes 1203 may be configured to, with the one or more processors 1201, cause the apparatus 1200 at least to perform any operation of the method as described in connection with FIG. 11. In such embodiments, the apparatus 1200 may be implemented as at least part of or communicatively coupled to the network node to implement MBSTF as described above. As a particular example, the apparatus 1200 may be implemented as a network node to implement MBSTF.

Alternatively or additionally, the one or more memories 1202 and the computer program codes 1203 may be configured to, with the one or more processors 1201, cause the apparatus 1200 at least to perform more or less operations to implement the proposed methods according to the exemplary embodiments of the present disclosure.

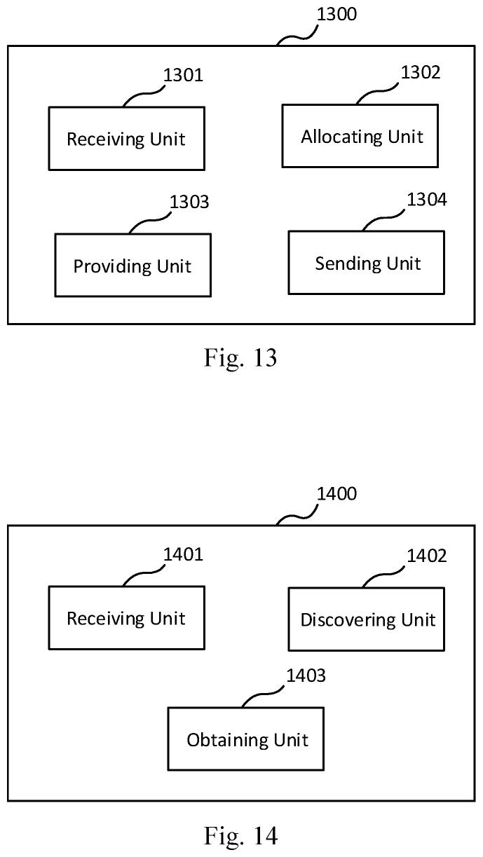

FIG. 13 is a block diagram illustrating an apparatus 1300 according to some embodiments of the present disclosure. As shown in FIG. 13, the apparatus 1300 may comprise a receiving unit 1301, an allocating unit 1302, a providing unit 1303, and a sending unit 1304. In an exemplary embodiment, the apparatus 1300 may be implemented in an MBSF. The receiving unit 1301 may be operable to carry out the operation in block 804. The allocating unit 1302 may be operable to carry out the operation in block 806. The providing unit 1303 may be operable to carry out the operation in block 808. The sending unit 1304 may be operable to carry out the operation in block 810. Optionally, the receiving unit 1301 and/or the allocating unit 1302 and/or the providing unit 1303 and/or the sending unit 1304 may be operable to carry out more or less operations to implement the proposed methods according to the exemplary embodiments of the present disclosure.

FIG. 14 is a block diagram illustrating an apparatus 1400 according to some embodiments of the present disclosure. As shown in FIG. 14, the apparatus 1400 may comprise a receiving unit 1401, a discovering unit 1402, and an obtaining unit 1403. In an exemplary embodiment, the apparatus 1400 may be implemented in a network function, e.g. AMF or SMF. The receiving unit 1401 may be operable to carry out the operation in block 1002. The discovering unit 1402 may be operable to carry out the operation in block 1404. The obtaining unit 1403 may be operable to carry out the operations in blocks 1006 and 1008. Optionally, the receiving unit 1401 and/or the discovering unit 1402 and/or the obtaining unit 1403 may be operable to carry out more or less operations to implement the proposed methods according to the exemplary embodiments of the present disclosure.

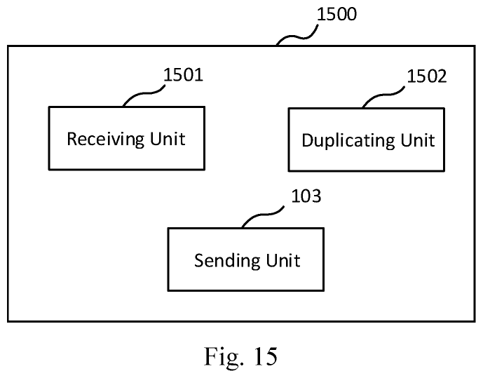

FIG. 15 is a block diagram illustrating an apparatus 1500 according to some embodiments of the present disclosure. As shown in FIG. 15, the apparatus 1500 may comprise a receiving unit 1501, a duplicating unit 1502, and a sending unit 1503. In an exemplary embodiment, the apparatus 1500 may be implemented in an MBSTF. The receiving unit 1501 may be operable to carry out the operation in block 1102. The duplicating unit 1502 may be operable to carry out the operation in block 1104. The sending unit 1503 may be operable to carry out the operation in block 1106. Optionally, the receiving unit 1501 and/or the duplicating unit 1502 and/or the sending unit 1503 may be operable to carry out more or less operations to implement the proposed methods according to the exemplary embodiments of the present disclosure.

Appendix: Configuration for MBS

In clause 8.2.3 of TR 23.757 V1.2.0, the following are included:

Configuration of a Multicast Group in the 5GC can Occur:
when the first UE joins the multicast group;
based on static configuration:
Triggered by an AF request via the NEF.

Among the above,
“Triggered by an AF request via the NEF” is described as one step for multicast MBS Session configuration.

For MBS broadcast, there are two steps, i.e. TMGI allocation (so that the AF can perform service announcement to the UEs) and MBS Session start. The 2-step approach is important to ensure the UEs have received service announcement (including TMGI) before MBS Session is started. Besides, if TMGI is kept allocated when an MBS Session is stopped, the 2-step approach can avoid sending new service announcement to the UEs when the MBS Session is started again.

To align the AF configuration for both multicast and broadcast MBS Sessions, it's proposed to adopt the 2-step approach.

Besides, when the AF is in trusted domain, NEF may not be deployed. It's proposed to use MBSF instead of “NEF/MBSF”.
“based on the static configuration” is not clarified how it's supposed to work, and it's proposed not to pursue it.
“when the first UE joins the multicast group” is described as follows, however, the handling of SMF storing itself in UDR depends on the discussion of SMF selecting MB-SMF which is still open.

If the multicast context for the multicast group does not exist, then SMF creates it when the first UE joins the multicast group, stores the multicast context including itself as multicast controlling SMF in the UDR”

If the AF does not provide service requirement, only default QoS can be applied to the MBS Session by 5GC, therefore the QoS requirement from certain services may not be supported, e.g. in IPTV, there could be different QoS requirement for SD, HD, 4K and 8K channels.

Furthermore, at first UE join, if the multicast context for the multicast group does not exist, how does SMF differentiated the following two cases?
Case-1: the multicast session needs to be configured by the AF but hasn't been configured yet, therefore the SMF should reject the UE join.
Case-2: the multicast session does not need to be configured by the AF and the SMF should create it and accept the UE join.

Based on the above,
Proposal-1: It is proposed to clarify the two steps for MBS Session configuration, which is applicable for both multicast and broadcast communications.
Proposal-1a: It's proposed to use MBSF instead of “NEF/MBSF”.
Proposal 2: It's proposed not to pursue “based on static configuration” as an option of configuration for MBS.
Proposal 3: It's proposed not to pursue “when the first UE joins the multicast group” as an option of configuration for MBS.

It is proposed to capture the following in 3GPP TS 23.247.

7.0.1 Configuration for MBS The configuration for MBS Session is used by the AF to start the MBS Session towards 5GC, and it applies to both multicast and broadcast communications.

1. AF sends Allocate TMGI Request ( ) message to MBSF to request allocation of a TMGI to identify a new group.

NOTE 1: Depending on the configuration, for AF in trusted domain, MBSF can receive requests from AF directly, or via NEF, or via MBSF, or via NEF and MBSF.

2. MBSF allocates TMGI. MBSF discovers and selects an MB-SMF(s) using NRF or based on local configuration, and then sends an Provide TMGI Request ( ) message(s) to the MB-SMF(s).

3. MB-SMF responds to the MBSF.

4. The MBSF responds to the AF by sending a Allocate TMGI Response (TMGI) message.

5. The AF performs Service Announcement towards UE. The AF informs UEs about MBS Session information with TMGI, Higher Layer Multicast IP address (HL MC Address), MBS service area, session description information, etc.

The UE needs to be aware if the service is broadcast or multicast to decide if JOIN is to be performed.

6. The AF requests activation of an MBS Session by sending an Activate MBS Session Request (TMGI, HL MC Address, Service Requirement) message to the MBSF. AF has allocated a Higher Layer IP Multicast Address (HL MC Address). Service Requirement for the MBS Session is included. If multiple MBS QoS Flows are expected to be established, then the AF needs to provide different packet filters and associated service requirements.

7. The MBSF checks if the input parameters e.g. HL MC address are valid. MBSF sends an MBS Session Start (TMGI, Service Requirement) message to the MB-SMF.

8. [Optional] MB-SMF sends the TMGI for the MBS Session and the Service Requirement to the MB-PCF.

9. [Optional] The MB-PCF returns a 5G QoS Profile, which the MB-SMF uses as the 5G Authorized QoS Profile for the MBS Session. If multiple MBS service requirements are received, then MB-PCF will provide multiple 5G Authorized QoS Profiles,

10. MB-SMF sets up the N6 resources for the MBS Session in the MB-UPF and the N3 resources for transport multicast tunnelling using the LL MC address allocated for the TMGI.

Optionally Media reception in MB-UPF is un-tunnelled, in which case the MB-SMF also provides the HL MC Address so that the MB-UPF can send IGMP/MLD join and receive the (un-tunnelled) IP Multicast Media stream.

11. If N6 tunnelling is used, the MB-UPF allocates N6 tunnel information (e.g. UDP port and IP address) and returns to the MB-SMF.

If multiple MBS QoS Flows are established, the MB-UPF map the downlink MBS data to the MBS QoS Flow based on the packet filters which could be HL MC address and ports, or unicast UDP tunnel info.

12. The MB-SMF sends the MBS Session Start Response (TMGI) message to the MBSF. N6 Tunnel info is included in the response if N6 tunnelling is used.

13. The MBSF sends Activate MBS Session Response (TMGI) message to the AF. N6 Tunnel info is included in the response if N6 tunnelling is used.

The following part will be included in UE join procedure:

When the AMF or SMF receives UE request to join a specific MBS Session, the AMF or SMF discovers the MB-SMF as follows:
1a. In AMF-centric approach, UE sends MBS Session Join request to AMF with the MBS Session ID (TMGI).
1b. In SMF-centric approach, UE sends MBS Session Join request to SMF with the MBS Session ID (TMGI). It can be implemented via PDU Session Modification Request or PDU Session Establishment Request.
2. AMF or SMF discover MBSF. It can query NRF based on the MBS Session ID (TMGI) to get MBSF ID.
3. With the MBSF ID, AMF or SMF contact MBSF, providing MBS Session ID (TMGI) and UE location, and the AMF or SMF receives MB-SMF ID. If multiple MB-SMF IDs are involved for the same MBS Session, an alternative is, the MBSF returns multiple MB-SMF IDs with each of them associated with a service area, and AMF or SMF select the proper one base do the UE location.
4. With the MB-SMF ID, AMF or SMF contact MB-SMF. Providing MBS Session ID (TMGI) and UE location, it receives MBS Session Context.
5. AMF or SMF setup MB Session Resource towards NG-RAN:
   If MB-N3 tunnel is transported over multicast, NG-RAN can join the multicast group to receive data, which was provided in MBS Session Context.
   If MB-N3 tunnel is transported over point-to-point connection, NG-RAN informs MB-UPF about its MB-N3 tunnel endpoint via AMF and MB-SMF.
6a. In AMF-centric approach, AMF send MBS Session Join Accept to UE.
6b. In SMF-centric approach, SMF send MBS Session Join Accept to UE.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-35. (canceled)

36. A method implemented at a Multicast Broadcast Service Function, MBSF, comprising:
receiving a first request to allocate a Multicast Broadcast Service, MBS, session identifier, ID, for an MBS session from an Application Function, AF;
allocating the MBS session ID for the MBS session and selecting at least one Multicast Broadcast—Session Management Function, MB-SMF, based on the first request;
providing the allocated MBS session ID to the at least one MB-SMF; and
sending the allocated MBS session ID to the AF.

37. The method according to claim 36, wherein the at least one MB-SMF comprises multiple MB-SMF entities, and wherein the multiple MB-SMF entities are associated with different regions.

38. The method according to claim 36, wherein the first request comprises service area information for the MBS session, and wherein the at least one MB-SMF is selected based on the service area information.

39. The method according to claim 36, wherein the at least one MB-SMF is selected further based on local configuration or the at least one MB-SMF is selected by querying a Network Repository Function, NRF.

40. The method according to 36, wherein the MBS session ID is a Temporary Mobile Group Identity, TMGI.

41. The method according to claim 36, further comprising:
registering an MBS session ID range associated with the MBSF with a Network Repository Function, NRF.

42. The method according to 36, further comprising:
receiving a second request to start an MBS session from the AF;
determining at least one MB-SMF based on the second request;
sending the second request to the determined at least one MB-SMF;
receiving MBS session resource information for the MBS session from the at least one MB-SMF; and
sending the MBS session resource information to the AF.

43. The method according to claim 42, further comprising:
requesting, in response to the second request, user plane information for the MBS session from a Multicast Broadcast Service Transport Function, MBSTF; and
sending the user plane information in the MBSTF to the AF, without sending the MBS session resource information.

44. The method according to claim 42, further comprising:
querying, in response to the second request, a Policy Control Function, PCF, for quality of service, QoS, information for the MBS session based on service requirements in the second request.

45. The method according to claim 42, wherein the second request comprises an MBS session ID, service area information, and service requirements, and wherein the at least one MB-SMF is determined based on the service area information.

46. The method according to claim 42, wherein the MBS session resource information comprises N6 tunnel information for the MBS session in a Multicast Broadcast—User Plane Function, MB-UPF.

47. The method according to claim 42, wherein the first request and the second request are received in a single message.

48. A method implemented at a network function comprising:
receiving a message associated with an MBS session;
discovering an MBSF in response to the message;
obtaining identification information of an MB-SMF associated with the MBS session from the MBSF; and
obtaining an MBS session context for the MBS session from the MB-SMF identified by the identification information.

49. The method according to claim 48, wherein discovering an MBSF comprises:
querying an NRF for identification information of the MBSF based on an MBS session ID of the MBS session.

50. The method according to claim 48, wherein obtaining identification information of an MB-SMF associated with the MBS session from the MBSF comprises:
providing an MBS session ID of the MBS session to the MBSF;
obtaining the identification information of at least one MB-SMF, the identification information being associated with a service area; and
selecting, in response to receiving the identification information of multiple MB-SMF entities, the identification information of one of the at least one MB-SMF based on location information of a terminal device associated with the MBS session.

51. The method according to claim 48, wherein obtaining identification information of an MB-SMF associated with the MBS session from the MBSF comprises:
providing an MBS session ID of the MBS session and location information of a terminal device associated with the MBS session to the MBSF; and
obtaining the identification information of a specific MB-SMF.

52. The method according to claim 48, wherein obtaining an MBS session context for the MBS session from the MB-SMF identified by the identification information comprises:
providing an MBS session ID of the MBS session and location information associated with a terminal device associated with the MBS session to the MB-SMF; and
obtaining the MBS session context from the MB-SMF.

53. The method according to claim 48, wherein the network function is an Access and Mobility Management Function, AMF, and wherein the message is a request to join the MBS session by a terminal device or a request to create UE context during a handover procedure; or the network function is a Session Management Function, SMF, and the message is a request to join the MBS session by a terminal device or a request to update session management context during a handover procedure.

54. A network node to implement Multicast Broadcast Service Function, MBSF, comprising:
one or more processors; and
one or more memories comprising computer program codes,
the one or more memories and the computer program codes configured to, with the one or more processors, cause the network node to perform the method according to claim 36.

55. A network node to implement a network function comprising:
one or more processors; and
one or more memories comprising computer program codes,
the one or more memories and the computer program codes configured to, with the one or more processors, cause the network node to perform the method according to claim 48.
